(19) United States
(12) Patent Application Publication
(10) Pub. No.: US 2007/0113747 A1
(43) Pub. Date: May 24, 2007

(54) Slip roller or ductor roller for a printing machine

(75) Inventors: Peter Heiler, Forst (DE); Jaochim Sonnenschein, Muhltal (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG

(21) Appl. No.: 11/655,411

(22) Filed: Jan. 19, 2007

Related U.S. Application Data
(62) Division of application No. 09/658,712, filed on Sep. 11, 2000.

(30) Foreign Application Priority Data
Sep. 9, 1999 (DE) 199 43 028.4

(51) Int. Cl. B41F 5/00

(52) U.S. Cl. 101/216

(57) ABSTRACT

A roller for a printing machine, such as a slip roller or a ductor roller, has a circumferential surface provided with a surface structure and formed of a nonmetallic material. The surface structure is irregularly structured with a plurality of elongate elevations extending substantially parallel to the roller axis and parallel to one another. The elevations have an arithmetic average height, determined by the elevations, of at least 12 microns.

### CROSS-REFERENCE TO RELATED APPLICATIONS

This application is a division of copending application Ser. No. 09/658,712, filed Sep. 11, 2000; this application also claims the priority, under 35 U.S.C. § 119, of German patent application No. 199 43 028.4, filed Sep. 9, 1999; the earlier applications are herewith incorporated by reference in their entirety.

### BACKGROUND OF THE INVENTION

1. Field of the Invention

The invention relates to a roller for printing machines and, more particularly, to such a roller having a circumferential surface provided with a surface structure and being formed of a nonmetallic material.

Such a roller is described in the published Japanese Patent Document JP-A2 H3-221453 (1991). The roller described in that document is a metering roller which carries water and has a circumferential surface formed of rubber and having axially parallel grooves.

Further prior art includes a roller which is described in U.S. Pat. No. 4,033,262 and has a surface structure formed of rhomboidal bulges or humps, or a helical web. The roller described therein rotates at a circumferential speed which differs from the circumferential speed of an adjacent engaging roller, and is consequently a so-called slip roller. The patent specification does not contain any statements which relate to the material forming the circumferential surface of the roller.

In addition, the prior art also includes a roller described in the published German Non-prosecuted Patent Application (DE-OS) 26 59 557 and referred to therein as a distributor cylinder. The distributor cylinder rotates with slip and is provided with a profiled surface. No more specific statements as to the material of which the surface is formed are made in the published specification.

The prior art further likewise includes a vibrator-type inking unit described in the published German Document DE 298 19 744 U1 and having slip rollers, but no statements relating to the surface condition thereof are made in the described utility model.

Reference ought also be made to U.S. Pat. No. 4,949,637 and U.S. Pat. No. 5,540,145, wherein emulsion-film dampening units are described. These publications are mentioned at this point, because the roller according to the invention, which is described hereinbelow, is particularly suitable for use in such an emulsion-film dampening unit.

### SUMMARY OF THE INVENTION

It is accordingly an object of the invention to provide at least another improved roller for printing machines.

With the foregoing and other objects in view, there is provided, in accordance with one aspect of the invention, a rotatable body for a printing machine having a plurality of rollers, the rotatable body comprising:
a circumferential surface formed of a nonmetallic material with a surface structure, said circumferential surface being configured to carry a liquid and to define a surface of a slip roller for continuously contacting another roller of the plurality of rollers or a ductor roller for periodically contacting another roller of the plurality of rollers;
wherein the surface structure is irregularly structured with a plurality of elongate elevations extending substantially parallel to a roller axis and substantially parallel to one another and having an arithmetic average height, determined by the elevations, of at least 12 microns.

In accordance with another feature of the invention, the roller serves for carrying ink or emulsion.

In accordance with a further feature of the invention, during printing, the roller is in permanent engagement with two other rollers.

In accordance with an added feature of the invention, the surface structure is a groove running helically in the circumferential surface.

In accordance with an additional feature of the invention, the nonmetallic material is selected from the group of materials consisting of hard rubber and hard plastic material.

In accordance with yet another feature of the invention, the surface structure is made up of a multiplicity of dimples formed in the circumferential surface.

In accordance with yet a further feature of the invention, the surface structure is formed of slats.

In accordance with yet an added feature of the invention, average roughness of the surface structure, determined by the slats, is at least 12 microns.

In accordance with yet an additional feature of the invention, the nonmetallic material is selected from the group of materials consisting of soft rubber and soft plastic material.

In accordance with a concomitant aspect of the invention, there is provided a printing machine comprising at least one roller with a circumferential surface provided with a surface structure and formed of a nonmetallic material, the roller being selected from the group of rollers consisting of a slip roller and a vibrator roller.

Thus, the invention is based upon the concept that, by transferring the surface construction heretofore known for a metering roller to a slip roller and to a vibrator roller, specific advantages result for the last-mentioned rollers. The advantages could not be foreseen, nor could such a transfer be suggested in any way, because the intended use of a slip roller and the intended use of a vibrator roller is in each case quite different from that of a metering roller.

The slip roller rotates with rolling slip relative to a roller resting thereon and, together with the slip roller, forms a slip gap or nip. A liquid film transported through the slip gap or nip is not only split therein but is also sheared. As a result of the shear, shear forces become effective and are particularly great if the liquid is viscid and, for example, is an offset printing ink or a printing-ink/dampening-solution emulsion. With regard to the slip rollers disclosed by the prior art, the shear forces depend to a very great extent upon the set pressure in the slip gap or nip.

Due to the filigree machined structure of the slip-roller surface in the case of the slip roller according to the invention, and due to the properties of the material selected for the surface thereof, the shear forces that act upon the slip roller are advantageously reduced or compensated for and are virtually independent of the pressure. Consequently, the stability requirements for the mounting of the slip roller, and the sensitivity thereof to adjustment, are reduced.

The vibrator roller comes periodically into rolling contact with another roller. At the instant of time at which the vibrator roller strikes the other roller, the latter roller rotates with the circumferential surface thereof at a speed greater than zero relative to that of the vibrator roller, as a result of which the latter experiences a so-called starting jolt. The starting jolt is particularly severe if the vibrator roller is rotating in the opposite direction to the other roller at the instant that it strikes the other roller and, as a result of being frictionally entrained by the other roller, experiences a change in the direction of rotation thereof, after which the rollers roll on one another synchronously. By synchronously it is meant that one roller rotates in clockwise direction and the other roller rotates counterclockwise or opposite thereto.

Due to the filigree machined structure of the vibrator roller surface, and due to the properties of the material selected for the surface, the starting jolt is advantageously reduced, so that it cannot be propagated into the drive gear train of the printing unit containing the vibrator roller, and therefore cannot lead to ghosting faults.

Other features which are considered as characteristic for the invention are set forth in the appended claims.

Although the invention is illustrated and described herein as embodied in a roller for printing machines, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIG. 1 is a diagrammatic side elevational view of a printing machine having a printing unit to which a dampening unit and an inking unit including a vibrator roller are assigned;

FIG. 2 is a much-enlarged fragmentary view of FIG. 1 showing the dampening unit formed as an emulsion-film dampening unit including a slip roller;

FIG. 3 is a longitudinal view of a vibrator roller or slip roller showing a first embodiment of the surface structure thereof;

FIG. 4 is a cross-sectional view of FIG. 3 taken along the line IV-IV in the direction of the arrows;

FIG. 5 is a view like that of FIG. 3 showing a second embodiment of the surface structure of the vibrator roller or slip roller;

FIG. 6 is a cross-sectional view of FIG. 5 taken along the line VI-VI in the direction of the arrows; and

FIG. 7 is a view like those of FIGS. 3 and 5 showing a third embodiment of the surface structure of the vibrator roller or slip roller.

### DESCRIPTION OF THE PREFERRED EMBODIMENTS

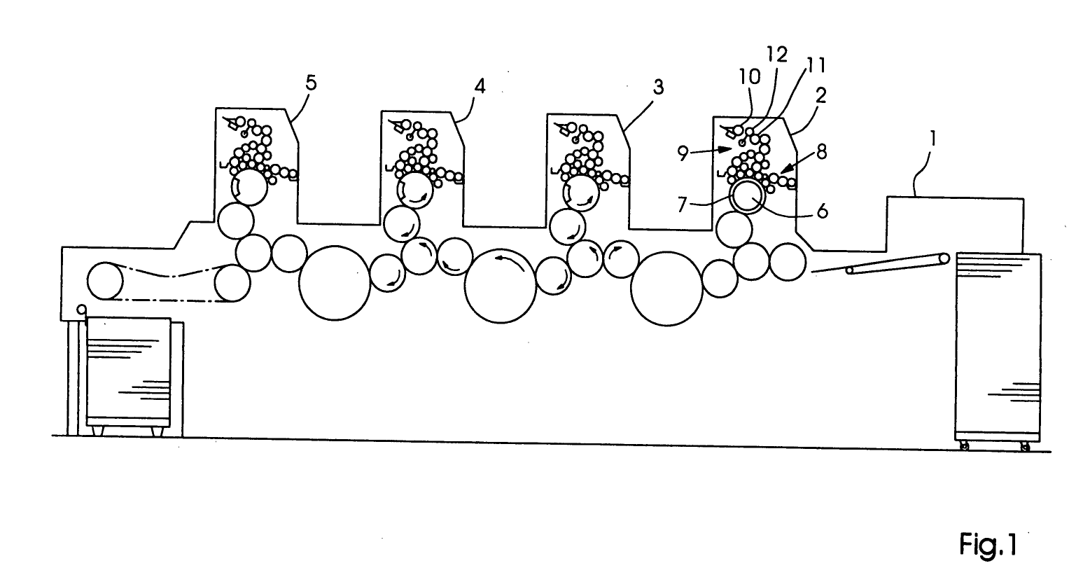

Referring now to the drawings and, first, particularly to FIG. 1 thereof, there is shown therein a printing machine 1 having one or more printing units 2 to 5. The printing machine 1 is a rotary printing machine for printing on sheet printing material. Each printing unit 2 to 5 includes a printing-form cylinder 6 with a printing form 7 clamped thereon, which is dampened by a dampening unit 8 and inked by an inking unit 9. The printing form 7 is an offset printing form such as an offset printing plate. The inking unit 9 includes a first roller 10, a second roller 11 and a vibrator roller 12, which oscillates with alternating contact between the rollers 10 and 11. The first roller 10 is an ink fountain or duct roller, from which the vibrator roller 12 transfers ink to the second roller 11, which is a distributor roller.

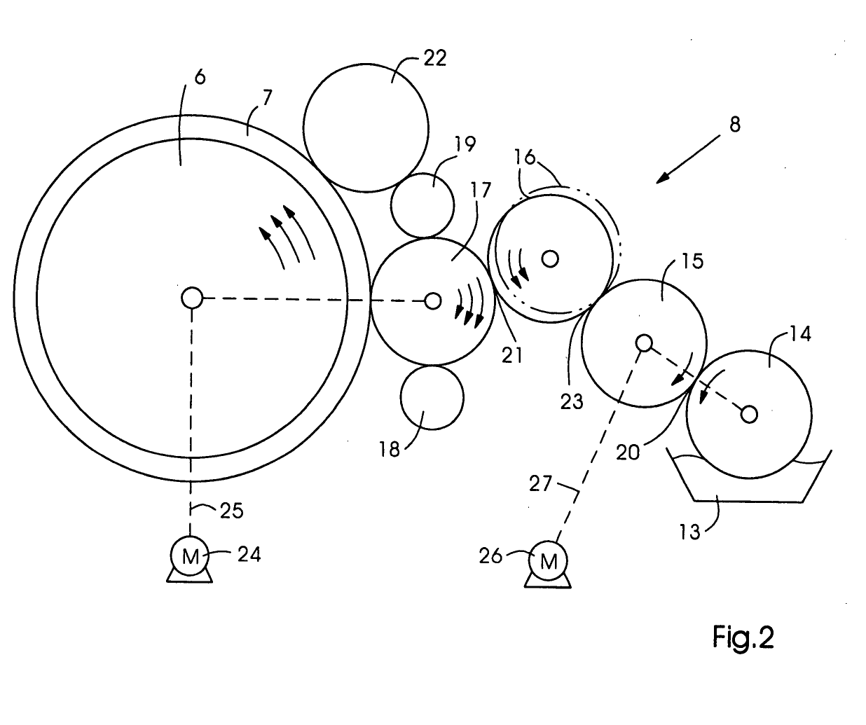

FIG. 2 shows in greater detail the dampening unit 8, which is constructed as an emulsion-film dampening unit and has a container or receptacle 13 for storing an alcohol-free or reduced-alcohol dampening solution therein. Such a reduced-alcohol or preferably alcohol-free dampening unit 8 is also referred to as a direct film dampening unit and, because of reduced emissions, is very advantageous from an environmental standpoint. The dampening unit 8 includes rollers 14 to 19 which roll on one another. The shortest transport path of the dampening solution from the container 13 onto the printing form 7 is provided by a roller train which includes at least four rollers, namely the rollers 14 to 17, and does not include the rollers 18 and 19. The circumferential surface of each roller 14 to 17 located in the aforementioned roller train is formed of a material which accepts ink, i.e., is ink-friendly, for example, rubber, which is advantageous from the point of view of the emulsion-forming in the dampening unit 8.

The third roller 14 is a dip roller and, together with the fourth roller 15, which is a metering roller, forms a press nip 20, wherein a dampening-solution film or, more precisely, an emulsion film, is produced. In the press nip 20, the printing-ink/dampening-solution emulsion on the fourth roller 15 is enriched with the dampening solution scooped out of the container 13 by the third roller 14.

The fifth roller 16 is advantageously a slip roller which, during printing, simultaneously rests permanently on the two rollers 15 and 17 in order to transfer emulsion from the roller 15 to the roller 17. For specific purposes, for example, in the event of interruptions in the printing or for the purpose of cleaning the dampening unit 8, a space can be produced between the rollers 16 and 17, by lifting the fifth roller 16 off or away from the sixth roller 17. The lifted-off position of the fifth roller 16 is illustrated in phantom in FIG. 2.

The sixth roller 17 is an applicator roller, which rolls on the printing form 7, while a seventh roller 18, in addition to the fifth roller 16, engages with the sixth roller 17. As viewed in the direction of rotation of the sixth roller 17, the seventh roller 18 is disposed downline from a press nip 21 and upline from a contact location formed by the sixth roller 17 and the printing form 7. The seventh roller 18 is a distributor roller which oscillates in the axial direction thereof. This is advantageous from the standpoint of stabilizing the emulsion and smoothing or evening out the liquid film on the sixth roller 17.

In addition to the fifth roller 16, two further rollers, namely the seventh roller 18 and an eighth roller 19, preferably rest on the sixth roller 17. As viewed in the direction of rotation of the sixth roller 17, the eighth roller 19 is disposed downline from the contact location between the sixth roller 17 and the printing form 7, and upline from the press nip 21. The eighth roller 19 is a connecting roller, which permits a selective connection between the dampening unit 8 and the inking unit 9 by resting simultaneously on the sixth roller 17 and a ninth roller 22 which, during printing, belongs to the inking unit 9 as an applicator roller. This construction is advantageous with regard to the operation of the dampening unit 8 coupled to the inking unit 9, the inking unit 9 being supplied with the dampening solution, and the dampening unit 8 being supplied with the printing ink via the eighth roller 19.

The arrows representing rotation shown in FIG. 2 symbolize the circumferential surface speeds of the rollers 14 to 17 and of the printing form or plate 7. The greater the number of rotation arrows shown alongside one another, the greater is the circumferential surface speed. The third roller 14 rotates at approximately the same circumferential surface speed as the fourth roller 15. The sixth roller 17 rotates at the same circumferential surface speed as the printing form 7, and can also rotate at a somewhat lower circumferential surface speed than that of the printing form 7.

In the press nip 21, a surface slip is effective between the rollers 16 and 17, the film of emulsion transported through the press nip 21 not only being split in the radial direction of the rollers 16 and 17 in the press nip 21 but also being sheared in the tangential direction. A press nip 23 of this type, which is comparable with the press nip 21 and in which, because of the rolling slip, shearing of the liquid film likewise occurs, is advantageously also located between the rollers 15 and 16.

The sixth roller 17 is rotated by a first drive 24, which also rotatively drives the printing-form cylinder 6 and, consequently, the printing form 7. The sixth roller 17 is form-lockingly or positively rotated by the first drive 24 via a first gear transmission 25, for example, a toothed gear mechanism, which is diagrammatically represented in FIG. 2 by broken lines. The fourth roller 15 is likewise form-lockingly or positively driven rotatively, more specifically by a second drive 26 formed as an electric motor via a second gear transmission 27 represented by broken lines, which may also be a toothed gear mechanism. In this regard, it is noted that a form-locking connection is one which connects two elements together due to the shape of the elements themselves, as opposed to a force-locking connection, which locks the elements together by force external to the elements. The second drive 26 is also used to drive the roller 14 via the second gear transmission 27.

The fifth roller 16 is rotatively driven by frictional entrainment with the fourth roller 15, so that a circumferential surface speed of the fifth roller 16 is established which lies between the circumferential surface speeds of the fourth roller 15 and the sixth roller 17.

If the angular speed of the sixth roller 17 is kept constant by the first drive 24, the slip that acts in the press nip 21 can be set finely in terms of the magnitude thereof by varying the angular speed of the fourth roller 15 and, therefore, of the fifth roller 16 by the second drive 26. By appropriate activation of the second drive 26, it is possible to set the speed differential by which the circumferential surface speed of the fifth roller 16 differs from that of the sixth roller 17, and is preferably lower than the circumferential surface speed of the sixth roller 17. By this advantageous speed control, it is, therefore, possible for the amount of liquid transferred from the fifth roller 16 to the sixth roller 17 for each revolution of the printing form 7 to be set precisely.

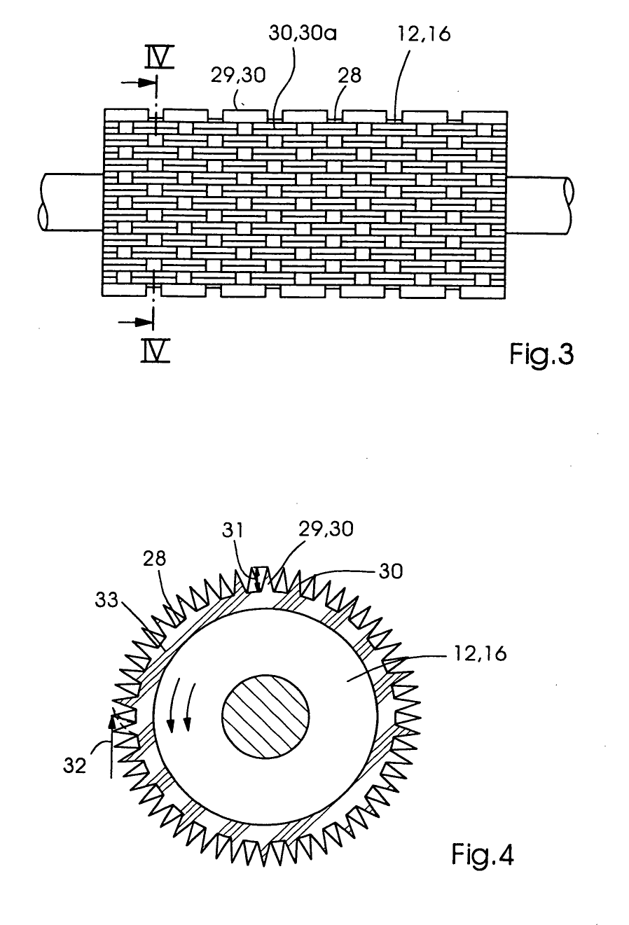

FIGS. 3 and 4 illustrate a first embodiment of the invention, according to which the vibrator roller 12 shown in FIG. 1 and the slip roller or fifth roller 16 shown in FIG. 2 can be constructed. A circumferential surface 28 of the rollers 12 and 16, respectively, is formed of a nonmetallic material which accepts ink, so that it accepts the printing ink or the printing-ink/dampening-solution emulsion well. The nonmetallic material is applied, as a soft coating 33 formed of rubber or plastic, or as such a roller cover, to a hard roller core of the rollers 12 and 16, respectively.

The circumferential surface 28 has a roughness, advantageously produced by removing material, with an average roughness which is 12 μm or more. The surface structure 29 produced by machining the circumferential surface 28 may be formed by using a suitable grinding disk with a sufficiently coarse grain during the cylindrical grinding of the circumferential surface 28, i.e., when regrinding the soft coating previously applied to the respective roller 12, 16. In a comparison with the production of conventional smooth rollers, no additional costs occur during the production of the structured rollers 12 and 16, respectively.

The surface structure 29 is illustrated in a very exaggerated manner in FIGS. 3 and 4, and is formed of structure elements 30, each of which, as viewed in the axial direction of the rollers 12 and 16, respectively, is shorter than the respective roller 12, 16. The structure elements 30 can be, for example, a few millimeters long. The longer side of the structure elements 30 extend substantially axially parallel with the respective roller 12, 16 and with one another. In the cross-sectional view of FIG. 4, each structure element 30 has a broad foot and extends radially outwardly to a tip. In other words, if very much magnified, each of the elevated structure elements 30 appears like a small pointed roof. The distance 31 from the point to the foot of the structure element 30 embodies an individual roughness. The arithmetic mean of such individual roughnesses of five successive individual measured sections is the averaged roughness R_{z}.

A significant feature of the structure elements 30 is the elasticity thereof in the circumferential direction of the respective roller 12, 16. By the bending of the structure elements 30, the force 32 acting thereon in the tangential direction is advantageously compensated for. In other words, the structured circumferential surface 28 does not present any great resistance to small deformations taking place in the circumferential direction, and the circumferential surface 28 absorbs the force 32 resiliently. In the case of the vibrator roller 12, the force 32 is the force which causes the starting jolt when the vibrator roller 12 strikes the more rapidly rotating second roller 11. In the case of the slip roller 16 (fifth roller 16), the force 32 is the aforementioned shear force in the press nip 21.

In addition, from the surface structure 29, there results the beneficial effect that the printing ink or printing-ink/dampening-solution emulsion held from time to time between the elevated structure elements 30 has the effect of a partial thickening of the film layer in the resilient nip, referred to as the press nip 21, due to which the force 32, here the shear force 32, is not only compensated for but is also reduced. As a result of the partial thickening of the liquid film, the latter may be sheared more easily.

Due to the function thereof, the structure elements 30 can be referred to as slats 30a and, due to the shape thereof, as ridges or webs. The structure elements 30 are situated very close to one another. In FIGS. 3 and 4, the structure elements 30 are illustrated as being aligned very regularly in rows both in the circumferential direction and in the axial direction. Under practical production conditions, such a regular arrangement can be realized only with difficulty, and the structure elements 30 are irregularly arranged, but while maintaining the substantially axially parallel longitudinal alignment thereof relative to the respective roller 12, 16 and to one another. Due to the very large number of structure elements 30, which are offset relative to one another both in the circumferential and in the axial direction, and are arranged so as to overlap as viewed in both directions, absolutely uniform metering of the film in the press nip 21 is always assured.

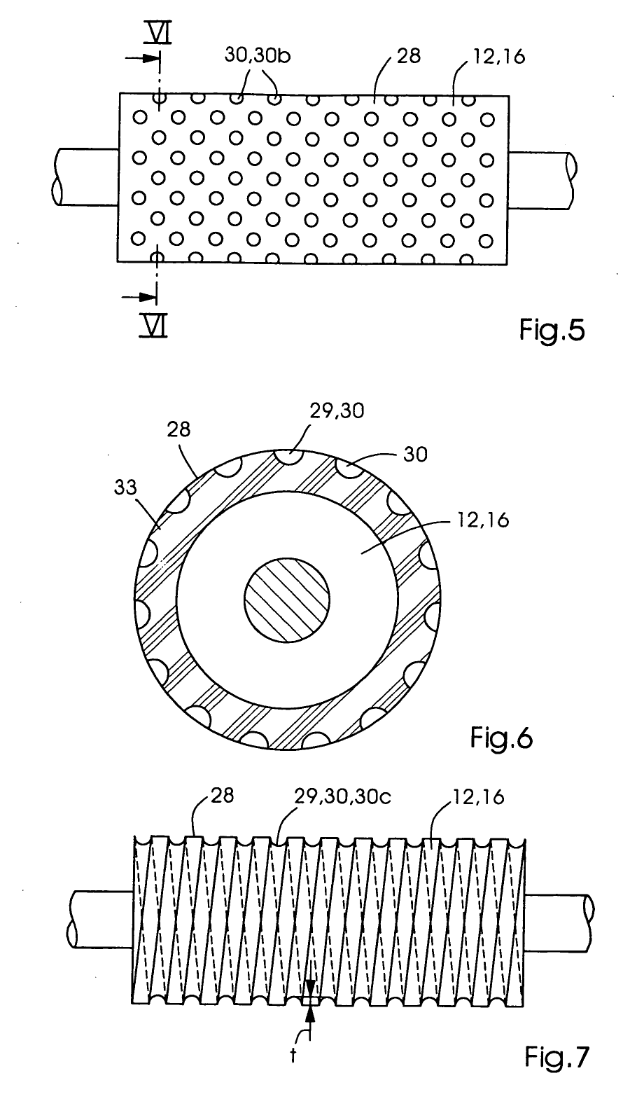

FIGS. 5 and 6 illustrate a second embodiment of the circumferential surface 28 which is suitable for constructing the rollers 12 and 16. In the second embodiment, the rollers 12 and 16, respectively, are coated with the same nonmetallic material as the corresponding rollers 12 and 16, respectively, of the first embodiment shown in FIGS. 3 and 4. In contrast with the first embodiment, the structure elements 30 of the second embodiment are not elevations on the circumferential surface 28, but rather, depressions which are formed therein.

The structure elements 30, which are somewhat punctiform or point-like as seen in plan view, are dimples 30b and are introduced into the nonmetallic material by a material-removing machining method. The structure elements 30 can be introduced into the circumferential surface 28 formed of the nonmetallic material by a metal-removing process, for example, drilling, or by a chemical process, for example, etching, or by a thermal process, for example, by partial evaporation of the material with a laser beam.

The structure elements 30 can be arranged irregularly, for example, randomly distributed, or regularly, for example, in a grid pattern, in the circumferential surface 28. As was also the case in the first embodiment of FIGS. 3 and 4, in the case of the second embodiment, the structure elements 30, as viewed in the circumferential direction, are arranged distributed around the entire rollers 12 and 16, respectively, and, as viewed in the axial direction thereof, substantially over the entire length of the roller or the length of the press nip 21.

When the structure elements 30 pass through the press nip 21, the printing ink or printing-ink/dampening-solution emulsion that is accumulated in the structure elements 30 is pressed out of the structure elements 30. As a result, a reinforced lubricating film is advantageously provided in the press nip 21, this film having the effect of reducing the shear force or the starting jolt.

The structure elements 30 can also be bores or holes which pass completely through the soft coating, the inner openings of the bores or holes being closed by the roller core whereon the soft coating is located. This is also to be understood to be included under the term dimples used for the structure elements 30.

FIG. 7 illustrates a third embodiment of the structure of the circumferential surface 28 of the roller 12 and 16. The surface structure 29 of the rollers 12 and 16, respectively, is formed of at least one structure element 30 which extends at least substantially in the circumferential direction of the rollers 12 and 16, respectively, and which is a helical groove 30c introduced into the circumferential surface 28. The structure element 30 runs helically around the axis of rotation of the respective roller 12, 16. As was also the case for the rollers 12 and 16 shown in FIGS. 3 to 6, the respective roller 12, 16 shown in FIG. 7 is structured over substantially the entire length thereof. In other words, the structure element 30 extends approximately from the left-hand end to the right-hand end of the roller.

A depth t of the structure element 30, which can also be referred to as the groove depth, is less than 1 mm, preferably less than 0.3 mm and, for example, about 0.1 mm.

In some applications, it may be advantageous to provide the rollers 12 and 16, respectively, with a number of such structure elements 30. For example, the respective roller 12, 16 may be provided with two helical grooves having respective pitches running in mutually opposite directions, similar to those in a left-hand thread and a right-hand thread. In addition, instead of a helical groove, in some applications, a number of mutually spaced and respective self-contained annular grooves could also be introduced into the circumferential surface 28 as the structure elements 30.

The nonmetallic material of which the circumferential surface 28 of the respective roller 12, 16 shown in FIG. 7 is formed is a hard rubber or a hard plastic material. For example, the circumferential surface 28 may be formed of hard rubber with a hardness of 80-90 Shore D. Each aforementioned structure element 30 can be introduced cost-effectively into the circumferential surface 28 by material-removing machining, for example by turning. The helical structure element 30 can be turned or cut into the circumferential surface 28 in a manner similar to the production of a thread.

In the third embodiment of the surface structure 29, which is shown in FIG. 7, a resultant advantage also is that the liquid film has a partially increased thickness in the press nip 21. As viewed over the length of the press nip 21, the thickness of the liquid film fluctuates between an upper and a lower limit, or the thickness of the liquid film alternately increases and decreases. It is therefore unnecessary for thin ink layers or emulsion layers to be sheared over the entire length of the press nip 21, and the force 32 is reduced.

We claim:

1. A rotatable body for a printing machine having a plurality of rollers, the rotatable body comprising:
a circumferential surface formed of a nonmetallic material with a surface structure, said circumferential surface being configured to carry a liquid and to define a surface of a slip roller for continuously contacting another roller of the plurality of rollers or a ductor roller for periodically contacting another roller of the plurality of rollers;
wherein said surface structure is irregularly structured with a plurality of elongate elevations extending substantially parallel to a roller axis and substantially parallel to one another and having an arithmetic average height, determined by said elevations, of at least 12 microns.

2. The rotatable body according to claim 1, wherein said elongate elevations form irregularly distributed ridges extending substantially parallel to the roller axis and offset relative to one another in a circumferential direction and in an axial direction.

3. The rotatable body according to claim 1, wherein said surface structure is formed by grinding a previously smooth surface of the nonmetallic material on the circumferential surface with a grinding disk.

4. The rotatable body according to claim 1, wherein said surface structure is configured to carry ink or emulsion.

5. The rotatable body according to claim 1, wherein said nonmetallic material is selected from the group of materials consisting of hard rubber and hard plastic material.

6. The rotatable body according to claim 1, wherein said nonmetallic material is selected from the group of materials consisting of soft rubber and soft plastic material.

7. The rotatable body according to claim 6, wherein said elevations are resiliently elastic in a circumferential direction of the roller.

8. The rotatable body according to claim 1, wherein said surface structure is defined by a multiplicity of elevations each having a relatively wide foot and merging to a tip in a radial section, and each having a length in an axial direction substantially shorter than an axial length of the roller.

9. A printing machine with a plurality of rollers, the printing machine comprising:
at least one roller with a circumferential surface formed of a nonmetallic material with a surface structure, said circumferential surface being configured to carry a liquid and to define a surface of a slip roller for continuously contacting another roller of the printing machine or a ductor roller for periodically contacting another roller of the printing machine;
wherein said surface structure is irregularly structured with a plurality of elongate elevations extending substantially parallel to a roller axis and substantially parallel to one another and having an arithmetic average height, determined by said elevations, of at least 12 microns.

10. The rotatable body according to claim 9, wherein said elongate elevations form irregularly distributed ridges extending substantially parallel to the roller axis and offset relative to one another in a circumferential direction and in an axial direction.

11. The rotatable body according to claim 9, wherein said surface structure is formed by grinding a previously smooth surface of the nonmetallic material on the circumferential surface with a grinding disk.

12. The printing machine according to claim 9, wherein said circumferential surface is configured to carry a viscid liquid.

13. The printing machine according to claim 9, wherein said surface structure is configured to carry ink or emulsion.

14. The printing machine according to claim 13, wherein said roller is said slip roller and, during printing, said roller is in permanent engagement with two other rollers.

15. The printing machine according to claim 9, wherein said nonmetallic material is hard rubber or hard plastic material.

16. The printing machine according to claim 9, wherein said nonmetallic material is soft rubber or soft plastic material.

17. The printing machine according to claim 9, wherein said circumferential surface is configured to carry an offset printing ink.

18. The printing machine according to claim 9, wherein said circumferential surface is configured to carry a printing-ink emulsion.

19. The printing machine according to claim 9, wherein said circumferential surface is configured to carry a dampening-solution emulsion.
